(19) United States
(12) Patent Application Publication
(10) Pub. No.: US 2012/0139833 A1
(43) Pub. Date: Jun. 7, 2012

(54) HANDWRITING INPUT DEVICE

(75) Inventor: PING-YANG CHUANG, Tu-Cheng (TW)

(73) Assignee: HON HAI PRECISION INDUSTRY CO., LTD., Tu-Cheng (TW)

(21) Appl. No.: 13/035,996

(22) Filed: Feb. 27, 2011

(30) Foreign Application Priority Data
Dec. 3, 2010 (TW) 99142004

(51) Int. Cl. G09G 5/08

(52) U.S. Cl. 345/157

(57) ABSTRACT

A handwriting input device includes a vibration sensor, a motion sensor, a communication unit, and a microcontroller. The vibration sensor is tuned to a range of frequencies that includes the expected vibration frequency generated by a finger wearing the device when the finger writes on a surface. The motion sensor senses movement of the device. The microcontroller generates cursor control signals according to the movement sensed by the motion sensor and generates handwriting activation signals when a frequency of vibration detected by the vibration sensor falls within the range of frequencies, and transmits the cursor control signals and the handwriting activation signals to an external electronic device communicating with the device through the communication unit to signal the external electronic device to control movement of a displayed cursor and displays the track of the movement of the displayed cursor.

### BACKGROUND

1. Technical Field

The present disclosure relates to handwriting input devices and, particularly, to a ring-shaped handwriting input device.

2. Description of Related Art

Conventional mice can generate cursor control signals to direct computers to control movement of a displayed cursor, but cannot direct the computers to display the track of the movement of the cursor. Conventional handwriting input devices can be employed to input handwritten information, but often need to work in tandem with digital panels, which are inconvenient for users to carry around.

### BRIEF DESCRIPTION OF THE DRAWINGS

The components of the drawings are not necessarily drawn to scale, the emphasis instead being placed upon clearly illustrating the principles of a handwriting input device. Moreover, in the drawings, like reference numerals designate corresponding parts throughout several views.

FIG. 1 is a block diagram of a handwriting input device in accordance with an exemplary embodiment.

FIG. 2 is a schematic view of the handwriting input device of FIG. 1.

### DETAILED DESCRIPTION

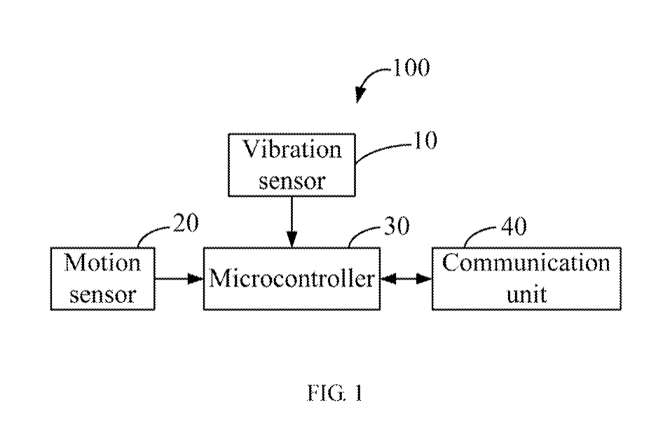

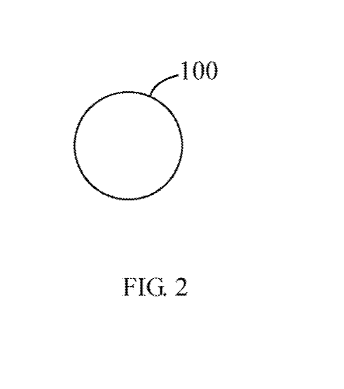

Referring to FIGS. 1-2, an embodiment of a handwriting input device 100 is illustrated. The device 100 includes a vibration sensor 10, a motion sensor 20, a microcontroller 30, and a communication unit 40. The device 100 can be worn on a user's finger. In this embodiment, the device 100 is substantially ring-shaped. The device 100 communicates with an external electronic device such as a computer through the communication unit 40. The communication unit 40 may include any one or more of a BLUETOOTH unit, an infrared unit, a USB interface, and a WIFI unit, for example.

The vibration sensor 10 is tuned to a range of frequencies that includes the expected vibration frequency generated by the finger wearing the device 100 when the finger writes on a surface such as a desktop or a mouse pad. The device 100 generates handwriting activation signals when a frequency of vibration detected by the vibration sensor 10 falls within the range of frequencies. In other words, if it is detected that a user is writing with the finger on a surface, the device 100 signals the computer to turn on its handwriting input function so that the tracks of the writing can be received and recorded by the computer and can be displayed on a display of the computer.

The motion sensor 20 senses movement of the device 100. The motion sensor 20 can include an accelerometer. The accelerometer may be a two-axis or a three axis accelerometer. The motion sensor 20 can further include a gyroscope.

The microcontroller 30 generates cursor control signals according to the movement sensed by the motion sensor 20 when a frequency of vibration detected by the vibration sensor 10 does not fall within the range of frequencies, and transmits the cursor control signals to the computer through the communication unit 40. The computer controls movement of a displayed cursor according to the cursor control signals in a manner similar to a conventional mouse. That is, when the finger wearing the device 100 moves without contacting a surface, the movement paths sensed by the motion sensor 20 are used to control movement of a displayed cursor in a manner similar to a conventional mouse. The microcontroller 30 generates the cursor control signals according to the movement sensed by the motion sensor 20 and generates the handwriting activation signals when a frequency of vibration detected by the vibration sensor 10 falls within the range of frequencies, and transmits the cursor control signals and the handwriting activation signals to the computer. The computer controls the movement of the displayed cursor and turns on the handwriting input function to display the track of the movement of the displayed cursor according to the cursor control signals and the handwriting activation signals. That is, when a frequency of vibration detected by the vibration sensor 10 falls within the range of frequencies, the microcontroller 30 determines that a user is writing with the finger wearing the device 100 on a surface, thus the microcontroller 30 generates the handwriting activation signals to signal the computer to turn on the handwriting input function to display the track of the writing. For example, if the finger wearing the device 100 slides on a contact surface to write “___”, the microcontroller 30 generates the cursor control signals and the handwriting activation 11 signals to direct the computer to move the displayed cursor and display the track “___”. With such configuration, a user can employ the device 100 to write conveniently.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A handwriting input device, comprising:
a vibration sensor tuned to a range of frequencies that comprises an expected vibration frequency generated by a finger wearing the handwriting input device when the finger wearing the handwriting input device writes on a surface;
a motion sensor to sense movement of the handwriting input device;
a communication unit; and
a microcontroller to generate cursor control signals according to the movement sensed by the motion sensor when a frequency of vibration detected by the vibration sensor falls within the range of frequencies, and transmits the cursor control signals to an external electronic device communicating with the handwriting input device through the communication unit to signal the external electronic device to control movement of a displayed cursor, the microcontroller further to generate the cursor control signals and handwriting activation signals when a frequency of vibration detected by the vibration sensor falls within the range of frequencies, and transmits the cursor control signals and the handwriting activation signals to the external electronic device to signal the external electronic device to control movement of the displayed cursor and display the track of the movement of the displayed cursor.

2. The handwriting input device as described in claim 1, wherein the communication unit comprises at least one unit selected from the group consisting of a BLUETOOTH unit, an infrared unit, a USB interface, and a WIFI unit.

3. The handwriting input device as described in claim 1, wherein the motions sensor is an accelerometer.

4. The handwriting input device as described in claim 3, wherein the accelerometer is a two-axis accelerometer.

5. The handwriting input device as described in claim 3, wherein the accelerometer is a three-axis accelerometer.

6. The handwriting input device as described in claim 3, wherein the motion sensor further comprises a gyroscope.

7. The handwriting input device as described in claim 1, wherein the handwriting input device is substantially ring-shaped.
